(19) United States
(12) Patent Application Publication
(10) Pub. No.: US 2016/0170507 A1
(43) Pub. Date: Jun. 16, 2016

(54) TOUCH PAD MODULE, REMOTE INPUT SYSTEM, AND METHOD OF CONTROLLING A REMOTE INPUT SYSTEM

(71) Applicant: Honda Motor Co., Ltd., Tokyo (JP)

(72) Inventors: Ross C. Miller, Hilliard, OH (US); Cody D. Grebe, Marysville, OH (US)

(21) Appl. No.: 14/964,809

(22) Filed: Dec. 10, 2015

Related U.S. Application Data
(60) Provisional application No. 62/090,644, filed on Dec. 11, 2014.

(51) Int. Cl. G06F 3/0354; G06F 3/0483; G06F 3/0484; G06F 3/0485; G06F 3/02; G06F 3/0482

(52) U.S. Cl. CPC G06F 3/03547; G06F 3/0227; G06F 3/0482; G06F 3/04847; G06F 3/04842; G06F 3/0485; G06F 3/0483; G06F 3/04845; G06F 2203/04808

(57) ABSTRACT

A touch pad module including a housing and a touch pad is provided. The housing is disposed on a center console of a vehicle and defines an opening. The touch pad is positioned within the opening. The touch pad has an arcuate contact surface curved inwardly with respect to the opening toward a central axis of the touch pad.

### BACKGROUND

The subject matter disclosed herein relates to a touch pad module and, more particularly, to a remote input system including a touch pad module for controlling automotive electronic systems.

Input systems for vehicles have increased in variety and scope as the available mechanical and electronic systems have increased in availability and complexity. Different technologies from touch screen displays to complex multifunction encoders have been employed to provide vehicle users different interactive experiences. There are various advantages and disadvantages to the different systems.

Traditional switches and buttons still have a place in modern automotive control systems. However, with the dramatic increase in complexity, automotive input systems need more flexibility without filling every available surface with a switch or button. Touch screens are one alternative that has been employed successfully. With the increased prevalence of touch technology in many electronic devices, users are becoming more adept with this type of interface. However, touch screens require a user to reach the screen and only touch on the desired selection. Driver distraction is always a concern and some users don't like to stretch to reach the screen. Alternatively, multifunction encoders having knobs that rotate, push to click, and/or a joystick functionality are alternatives to touch screens in many vehicles. While some of these devices may solve the problem of reaching for a touch screen and can be used without looking at the device, many are complex and take time and practice to learn how to operate.

What is needed is a remote input system that allows a user, such as a driver, to leverage knowledge and experience of current technology systems for application to a remote input system of a vehicle. A remote input system including a touch pad module configured to enable a user to ergonomically and easily control automotive systems while minimizing driver distraction is desirable.

### SUMMARY

According to one aspect, a touch pad module includes a housing and a touch pad. The housing is disposed on a center console of a vehicle and defines an opening. The touch pad is positioned within the opening. The touch pad has an arcuate contact surface curved inwardly with respect to the opening toward a central axis of the touch pad.

According to another aspect, a remote input system for a vehicle includes a touch pad module and a display. The touch pad module includes a housing and a touch pad. The housing is disposed on a center console of a vehicle and defines an opening. The touch pad is positioned within the opening. The touch pad has an arcuate contact surface curved inwardly with respect to the opening toward a central axis of the touch pad. The display is coupled in signal communication with the touch pad module for presenting selectable information for one or more systems of the vehicle based at least in part on one or more signals received from the touch pad module.

According to a further aspect, a method for controlling a remote input system for a vehicle is provided. The remote input system for a vehicle includes a display and a touch pad module having a touch pad. The touch pad module is disposed on a center console of a vehicle. The touch pad includes an arcuate contact surface. The arcuate contact surface follows an arc defined by a user's fingertip contacting the arcuate contact surface as the user's wrist rotates to move the fingertip in a transverse direction on the arcuate contact surface. The display is coupled in signal communication with the touch pad module for presenting selectable information for one or more systems of the vehicle based at least in part on one or more signals received from the touch pad module. The method includes communicating a signal from the touch pad to a processor in signal communication with the display when a user moves a finger along the arcuate contact surface of the touch pad to a region of the arcuate contact surface. Indicia presented on the display that is representative of information of a system of the vehicle is highlighted in response to the signal from the touch pad. The highlighted indicia is selected via the arcuate contact surface.

### BRIEF DESCRIPTION OF THE DRAWINGS

FIG. 1 is a schematic top plan view of a vehicle having an exemplary remote input system;

FIG. 2 is a schematic elevation view of the exemplary remote input system shown in FIG. 1;

FIG. 3 is an isometric view of an exemplary touch pad module for the exemplary remote input system shown in FIG. 2;

FIG. 4 is a top plan view of the exemplary touch pad module of FIG. 3;

FIG. 5 is cross-sectional view of the exemplary touch pad module of FIG. 4 along the line 5-5;

FIG. 6 is a side elevation view of another exemplary touch pad module; and

FIG. 7 is a side elevation view of another exemplary touch pad module.

Other aspects and advantages of certain embodiments will become apparent upon consideration of the following detailed description, wherein similar structures have similar reference numerals.

### DETAILED DESCRIPTION

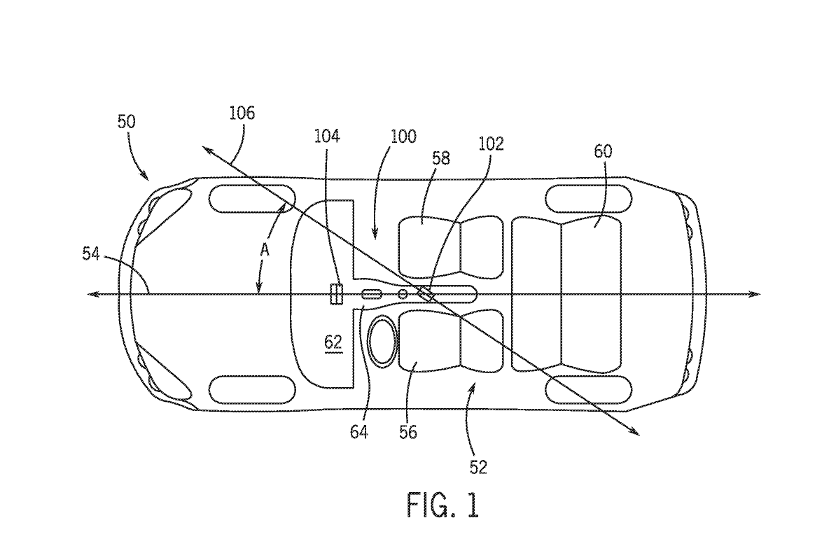

Referring initially to FIG. 1, a schematic top plan view of a vehicle 50 is depicted. The vehicle 50 includes a passenger area 52 and a central axis 54. The passenger area 52 generally includes a first seat 56 for a driver, a second seat 58 for a front passenger, and one or more rear seats 60. The passenger area 52 also includes a front console 62 and a center console 64. The center console 64 is generally aligned along the center axis 54 of the vehicle 50 and separates the first seat 56 and the second seat 58. The vehicle 50 also includes a remote input system 100 for controlling one or more electronic systems within the vehicle 50. The remote input system includes a touch pad module 102 and a display 104. In the embodiment depicted in FIG. 1, the display 104 is disposed on the front console 62 and the touch pad module 102 is disposed on the center console 64. In alternative embodiments, display 104 may include a heads-up display projected and/or reflected into a field of view of the driver and/or any other type of display device that allows the vehicle 50 to function as described herein.

Still referring to FIG. 1, in certain embodiments the touch pad module 102 includes a center axis 106. The center axis 106 of the touch pad module 102 and the central axis 54 of the vehicle 50 define an angle A. It is contemplated that the angle A is between 5 degrees and 45 degrees although claimed subject matter is not limited in this respect. In some embodiments, the center axis 106 of the touch pad module 102 is parallel to the central axis 54 of the vehicle 50. In the parallel embodiment, the center axis 106 may align on top of the central axis 54 of the vehicle 50. Alternatively, in the parallel embodiment the center axis 106 may be offset from the central axis 54 of the vehicle 50. In the offset parallel embodiment, the center axis 106 of the touch pad module 102 can be closer to the first seat 56 for the driver, or alternatively, the center axis 106 of the touch pad module 102 can be closer to the second seat 58 for the passenger.

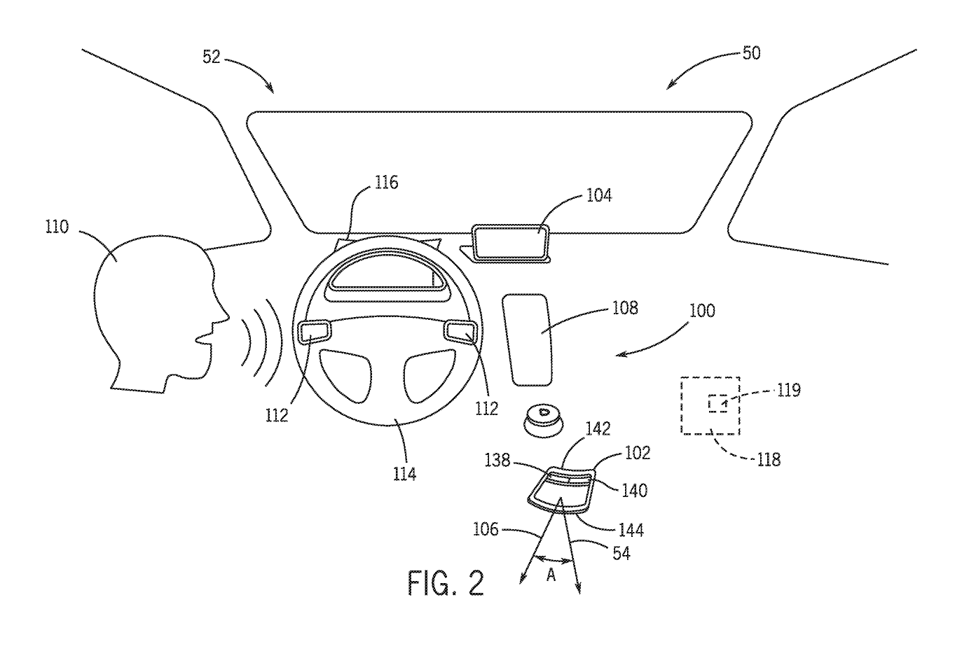

Referring further to FIG. 2, a schematic elevation view of an exemplary remote input system 100 is depicted within the passenger area 52 of the vehicle 50. The remote input system 100 includes the touch pad module 102 and the display 104. The touch pad module 102 is in signal communication with the display 104 for displaying visual indications associated with control of one or more electronic systems of the vehicle 50. Other means or devices may be included in the remote input system 100 for inputting or controlling the electronic systems. In certain embodiments, the remote input system 100 may include a control panel 108, which includes dedicated mechanical or electrical switches and knobs (not shown) for controlling specific functions of different systems. For example, there may be a volume and tune knob for the radio (not shown), or controls for the temperature in the passenger area 52. The remote input system 100 may also include one or more microphones (not shown) disposed throughout the passenger area 52. The microphones may be used for voice applications in a communication system or the remote input system 100 may respond to voice commands 110. In certain embodiments, the remote input system 100 also includes input devices 112 located on a steering wheel 114 of the vehicle 50. Further, the remote input system 100 may be capable of adjusting settings for a gauge display 116. The remote input systems 100 also includes one or more controllers 118 (shown schematically with dashed lines in FIG. 2) including one or more suitable processors 119 in signal communication with the touch pad module 102 and the display 104, as well as the other components of the remote input system 100 including, without limitation, the components described herein. The one or more controllers 118 and associated processor(s) 119 are configured to control operation of the remote input system 100 and the one or more related electronic systems of the vehicle 50 based, at least in part, on signals transmitted by and/or to the touch pad module 102 and/or the display 104.

It is contemplated that in some embodiments the controller 118 is a stand-alone unit that is in signal communication with all of the other components of the remote input system 100. In some embodiments, the controller 118 is included within, or coupled to, a controller area network (CAN) bus included within the vehicle 50. The controller 118 is also in signal communication with all of the requisite controllers and systems (not shown) of the vehicle 50. In certain embodiments, the controller 118 is included in the touch pad module 102. Alternatively, the controller 118 is included in the display 104. In other embodiments, the controller 118 is a component of one of the systems (not shown) of the vehicle 50.

The controller 118 may act or perform control functions disclosed herein, and may include one or more processors, memory and/or one or more programmable hardware elements. As used herein, the term “controller” is intended to include any types of processors, CPUs, microcontrollers, digital signal processors, or other suitable devices capable of executing software instructions. Further, memory may include a non-volatile medium, e.g., a magnetic media or hard disk, optical storage, or flash memory; a volatile medium, such as system memory, e.g., random access memory (RAM) such as DRAM, SRAM, EDO RAM, RDRAM, RAM, or DRDRAM, for example; or an installation medium, such as software media, e.g., a CD-ROM, or floppy disks, on which configuration data and programs may be stored and/or data communications may be buffered. The term “memory” may also include other types of known or future developed memory or combinations thereof.

Still referring to FIGS. 1 and 2, it is contemplated that a variety of different systems of the vehicle 50 can be controlled using the touch pad module 102 and the display 104 of the remote input system 100. Some non-limiting examples of systems that can be controlled by the remote input system 100 include an environmental control system for the passenger area 52, a navigation system, a communication system, and/or an entertainment system. It is also contemplated that mobile wireless devices may be connected to and in signal communication with the display 104 through a physical connection or a wireless connection. The remote input system 100 may be configured to control any mobile devices in signal communication with the remote input system 100.

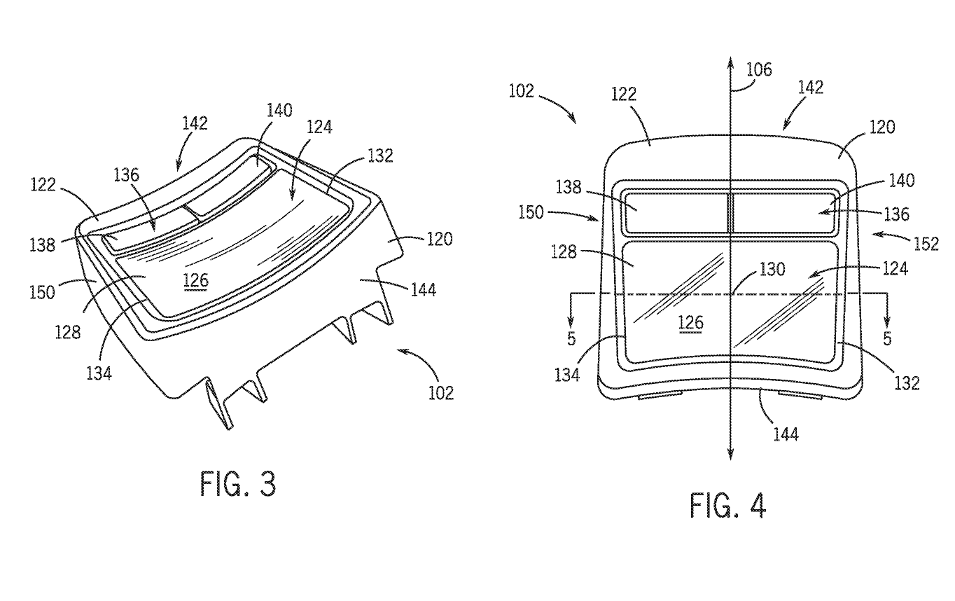

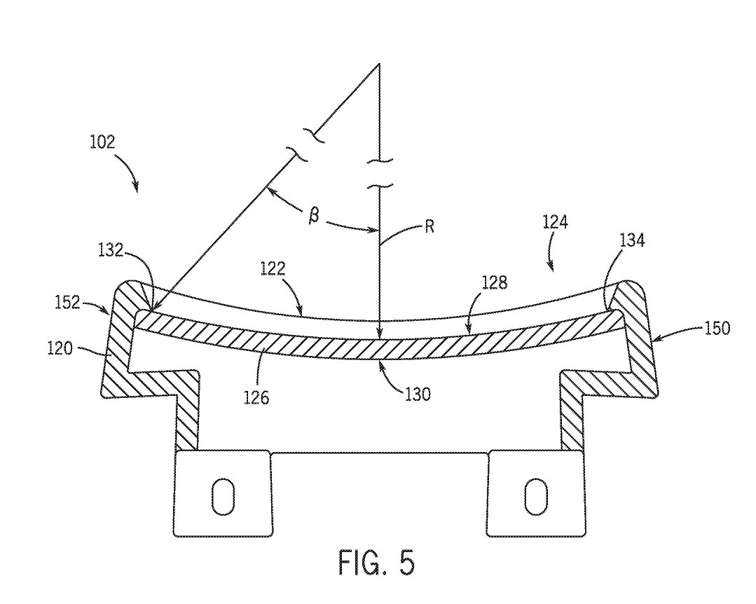

As shown in FIGS. 3 and 4, an exemplary embodiment of a touch pad module 102 is depicted. The touch pad module 102 includes a housing 120, which includes a curved top surface 122. An opening 124 is defined by or through the top surface 122. Disposed within the opening 122 is a touch pad 126. The touch pad 126 includes an arcuate contact surface 128. In a particular embodiment, the arcuate contact surface 128 is concave, that is, curved inwardly toward the center axis 106 that includes a center point 130, shown in FIGS. 4 and 5. The center axis 106 and the center point 130 are lower (i.e., closer to the floor of the vehicle 50) than a first lateral edge 132 and an opposite second lateral edge 134 of the touch pad 126. It is contemplated that the arcuate contact surface 128 is curved to follow an arc of a user's fingertips in a transverse direction to the center axis 106 of the touch pad module 102 as the user naturally rotates his or her wrist. Furthermore, the curvature of arcuate contact surface 128 allows the user to locate the center axis 106 or the center point 130 solely by feel, that is, without looking at the touch pad module 102. Knowing the location of the center axis 106 or the center point 130 allows the user to more accurately make selections using the touch pad module 102. Knowing the location of the center axis 106 or the center point 130 without looking at the touch pad module 102 allows the user to make selections using the touch pad module 102 while maintaining visual attention forward of the vehicle 50 (i.e., keeping their eyes on the road). In one embodiment, a radius of curvature R, shown in FIG. 5, of the arcuate contact surface 128 is about 112.5 millimeters (mm). In certain embodiments, the radius of curvature R is between 95 mm and 130 mm, more specifically 105 mm and 120 mm, or, even more specifically 110 mm and 115 mm and all subranges therebetween. The arcuate contact surface 128 can also be described by an angle B formed between the center point 130 and the first lateral edge 132. As the radius of curvature R of the curved surface is changed, the angle B will increase or decease accordingly. A larger angle B corresponds to a smaller radius of curvature R. Conversely, a smaller angle B corresponds to a larger radius of curvature R. The maximum angle B is 90°, which would correspond to the arcuate contact surface 128 forming a half circle within the opening 124. In one embodiment, the angle B, shown in FIG. 5, is about 18.4°. In certain embodiments, the angle B is between 16.1° and 21.5°, more specifically 17.4° and 19.6°, or, even more specifically 18.8° and 18.1° and all subranges therebetween.

It is also contemplated that in different exemplary embodiments the arcuate contact surface 128 can have different characteristics. In one embodiment, the arcuate contact surface 128 is curved inwardly toward an axis perpendicular (not shown) to the central axis 106 and that also includes the center point 130. In another embodiment, the curved arcuate surface 128 is curved inwardly toward the center point 130 and forms a spherically concave surface.

Still referring to FIGS. 3 and 4, in certain embodiments the touch pad module 102 includes one or more additional openings 136 defined by or through the curved top surface 122 of the touch pad housing 120. As shown in FIGS. 3 and 4, a first button 138 and a second button 140 are disposed within the additional opening 136. It is contemplated that in some embodiments only the first button 138 is disposed within the additional opening 136. In certain embodiments, there may be more than two buttons disposed within the additional opening 136. In the embodiment shown in FIGS. 2-5, the additional opening 136 and the first button 138 and/or the second button 140 are positioned proximate to a first or front end 142 of the housing 120 with the touch pad 126 positioned between the buttons 138, 140 and the user. In this configuration, the user reaches over or across the touch pad 126 to actuate the first button 138 and/or the second button 140. In an alternative embodiment (not shown), the first button 138 and/or the second button 140 are positioned proximate to a second or rear end 144 of the housing 120 opposing the front end 142. In this configuration, the user reaches over or across the first button 138 and the second button 140 to use the touch pad 126. It is also contemplated that the first button 138 and the second button 140 may be positioned on a first lateral side 150 or a second lateral side 152 of the housing 120. In these embodiments, the user may use a thumb or one or more fingers to actuate the first button 138 and/or the second button 140. One having skill in the art would recognize that the positioning of the buttons 138, 140 could be accomplished in a variety of ways so as to accommodate multiple ergonomic configurations. It is also contemplated that multiple sets of buttons 138, 140 could be located in a variety of positions on the touch pad module 102 in order to accommodate different preferences among users.

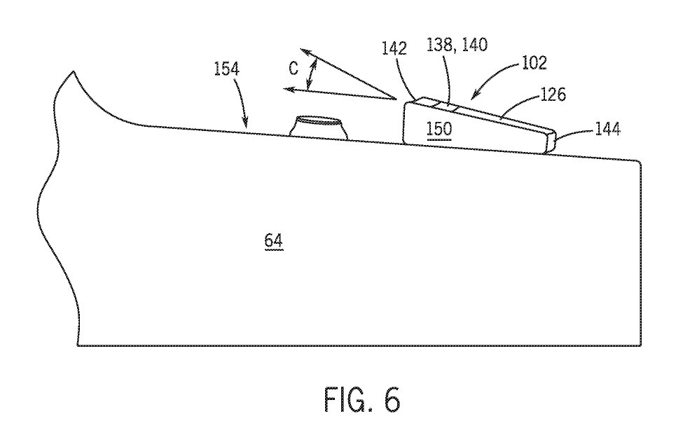

Referring now to FIG. 6, a portion of the center console 64 is depicted with the touch pad module 102 disposed thereon. In this exemplary embodiment, the touch pad module 102 is positioned such that the first end 142 is closer to a location at which the center console 64 connects or transitions into the front console 62. In this embodiment, the arcuate contact surface 128 of the touch pad 126 forms an angle C through the center point 130 with respect to a mounting surface 154 of the center console 64. In one embodiment, the angle C, shown in FIG. 6, is about 15°. In certain embodiments, the angle C is between 5° and 25°, more specifically 10° and 20°, or, even more specifically 12° and 18° and all subranges therebetween. In the embodiment depicted in FIG. 6, the top surface 122 has a negative slope and, thus, the touch pad surface 126, the first button 138, and the second button 140 are tilted or angled toward the user. It is contemplated that, as described above, the first button 138 and the second button 140 may be positioned in different locations to provide one or more configurations of the touch pad module 102.

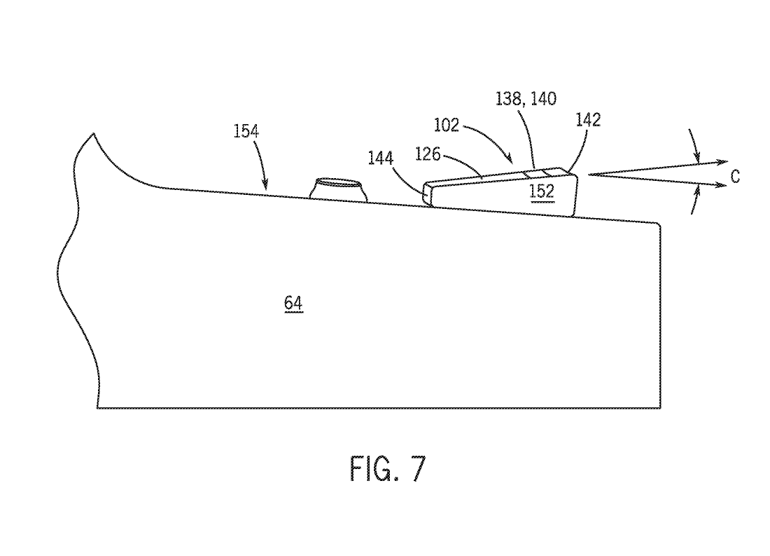

Referring now to FIG. 7, another exemplary embodiment of the touch pad module 102 is disposed on the mounting surface 154 of the center console 64. In this embodiment, the orientation of the touch pad module 102 is reversed relative to the embodiment shown in FIG. 6. That is, the second end 144 of the touch pad module 102 is closer to a location at which the center console 64 connects or transitions into the front console 62. The angle C defines the angle between the arcuate contact surface 128 of the touch pad 126 through the center point 130 and the mounting surface 154. In one embodiment, the angle C, shown in FIG. 7, is about 15°. In certain embodiments, the angle C is between 5° and 25°, more specifically 10° and 20°, or, even more specifically 12° and 18° and all subranges therebetween. In this embodiment, the top surface 122 and the touch pad 126 have a positive slope and are tilted away from a user. It is contemplated that as described above, the first button 138 and the second button 140 may be positioned in different locations to provide one or more configurations of the touch pad module 102. Furthermore, although illustrated in FIGS. 6 and 7 as extending upward from the mounting surface 154, the touch pad module 102 may be positioned such that the first lateral edge 132 and second lateral edge 134 are flush with the mounting surface 154 or recessed within the mounting surface 154.

It is also contemplated that the touch pad 126 and the first button 138 and the second button 140 are in signal communication with the display 104. The display 104 presents selectable information to the user. The user can select or change the information on the display by actuating the first button 138 and/or the second button 140, using the touch pad 126, or any of the other devices and means that may be part of the remote input system 100 as described above. More specifically, when a user touches the touch pad 126 with a fingertip or slides a fingertip across the arcuate contact surface 128, a signal is communicated to the controller 118 in signal communication with the display 104. In one embodiment the detection of a user's touch substantially along the central axis of the touch pad 126 may correspond to a highlighting of a selectable selection that is displayed substantially along a central axis of the display 104. In some embodiments, a user sliding a fingertip along the arcuate contact surface 128 will signal to the display 104, via the controller 118, to indicate a selection is ready to be selected by highlighting the selection, for example. If the user continues to slide his or her fingertip along the arcuate contact surface 128, the display 104 highlights the next selectable selection on the display 104 corresponding to the direction of movement of the user's fingertip. In this way, the user can change the selectable information to be selected by sliding a fingertip across the arcuate contact surface 128 of the touch pad 126. Once the desired selectable information is indicated on the display 104, the user may tap or touch the arcuate contact surface 128 to make a selection. Tapping or touching the arcuate contact surface 128 transmits a signal to the display 104 via the controller 118 indicating that a selection has been made. This signal may result in one or more of the following: more information about the selection may be presented on the display 104, one or more systems of the vehicle 50 may be activated, and one or more parameters of a system may be adjusted. For example, a user may slide a fingertip across the arcuate contact surface 128 until an indicator for an audio system is highlighted on the display 104. The user then taps the arcuate contact surface 128 to select the audio system and a new menu of selections are presented on the display 104 to the user relating to the audio system. The user can repeat the process until the radio is activated and tuned to a desired station at a desired volume, for example. Each time the user interacts with the touch pad module 102, a signal is transmitted via the controller 118 to the display 104.

It is also contemplated that in some embodiments the first button 138 and the second button 140 have dedicated functions. For example, in some embodiments, when the vehicle 50 is started a first or home set of selectable information may be presented on the display 104. The user then can follow the process as described above to select any of the selectable information presented on the display 104 to control various systems of the vehicle. In some embodiments, the first button 138 may include a dedicated function of returning the selectable information presented on the display 104 to the first set of selectable information, regardless of the selectable information presented on the display 104. Alternatively, the second button 140 may have a dedicated function of changing the selectable information presented on the display 104 to the previous set of selectable information that was presented on display 104 before the last selection by the user. In this embodiment, the first button 138 is a “home” button and the second button 140 is a “back” button. One having ordinary skill in the art would understand the surface indicia to indicate these types of functions and physical arrangement of such buttons. By depressing the first button 138 or the second button 140 the user initiates the controller 118 to transmit one or more appropriate signals to the display 104 to present the first set or the previous set of selectable information.

In certain embodiments, the positioning of the fingertip on the touch pad is correlated directly to a position on the display. That is, every point on the arcuate contact surface 128 correlates directly to a position on the display 104. With absolute positioning, the display 104 may be partitioned into a plurality of regions with each region representing a selection of selectable information. A user need only touch a region on the arcuate contact surface 128 that corresponds to a region on the display 104 to highlight and make a selection. In some embodiments, relative positioning is employed. As the user moves one or more fingertips along the arcuate contact surface 128 of the touch pad 126 information is highlighted or a pointer is moved across the display 104. If the user's fingertip reaches an edge of the arcuate contact surface 128 the user can pick up the fingertip and move to a contact point at another location and begin moving the fingertip again to continue signaling the display selection. One advantage of relative positioning is that the sensitivity of the touch pad 126 can be adjusted to a specific user's preference. Some users like a small movement on the touch pad 126 to correspond to a large movement on the display 104. Other users may want a small amount of movement on the display 104 to correspond to a relatively larger amount of movement on the touch pad 126.

In certain embodiments, it is contemplated that a user may make a selection of information presented and highlighted on the display 104 by pressing on the arcuate contact surface 128 of the touch pad 126 and actuating a switch (not show) to send a signal to the display 104. The touch pad 126 can be mounted within the touch pad housing 120 such that a small amount of movement is allowed. This method of making a selection would enable positive feedback to the user that a selection has been made.

It is also contemplated that in some embodiments more than one touch pad module 102 may be mounted in the vehicle 50. For example, the touch pad module 102 may be mounted on an inside surface of a door adjacent the driver's seat (not shown) to accommodate drivers that prefer to use a left hand. Alternatively, a plurality of touch pad modules 102 may be provided at different locations for the passengers to control personal entertainment systems (not shown). For example, passengers located in the rear passenger seats 60 may have touch pad modules 102 disposed in a location that is conveniently accessed to control an entertainment system that includes displays only visible to them, such as in the back of the headrests for the front seats or mounted to the interior surface of the ceiling of the vehicle 50.

It is also contemplated that the touch pad 126 could be used with one or more gloved fingertips as well as one or more bare fingertips in some embodiments. Further, it is contemplated that the touch pad 126 could support different gestures by one or more fingers that send specific signals via the controller 118 to the display 104. For example, two fingertips moving relative to each other can provide a specific signal to the display 104 for specific systems. In certain embodiments, two fingers sliding in contact with the arcuate contact surface 128 transversely to the center axis 106 can transition the information presented on the display 104 between systems or pages of selectable information. In certain embodiments, two fingers sliding in contact with the arcuate contact surface 128 parallel to the center axis 106 can scroll the selectable information vertically on the display 104. Further, in certain embodiments, two fingers sliding in contact with the arcuate contact surface 128 in a circular or rotational pattern can rotate an image presented on the display 104. It is also contemplated that two finger pinch and/or expand gestures may initiate zooming of an image displayed on the display. Moreover, contact of three or four fingers detected on the contact surface 128 may trigger a predefined function. Alternatively, gestures with one or more fingertips sliding on the arcuate contact surface 128 can replicate the signals of the first button 138 and/or the second button 140. It is also contemplated that in certain embodiments the controller 118 is configured to recognize input on the arcuate contact surface 128 when the user traces the shape of letters and/or numbers with a fingertip, for example, when entering an address into a navigation system or numbers for a radio station. Further, in some embodiments gestures including one or more fingertips sliding in contact with the arcuate contact surface 128 can perform specific functions, for example, controlling specific functions within a system on the display 104, such as a web browser. It is also contemplated that in certain embodiments touching the arcuate contact surface 128 causes a menu of selectable information to be presented on the display 104. In certain embodiments, gestures with one or more fingertips sliding in contact with the arcuate contact surface 128 can be programmed by the user to represent a shortcut to a specific set of selectable information, a specific setting adjustment, or multiple simultaneous functions. For example, in one embodiment a specific gesture can be programmed to turn on the radio to a specific radio station at a specific volume level.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments.

1. A touch pad module, comprising:
a housing disposed at least one of on and at least partially within a center console of a vehicle, the housing defining an opening; and
a touch pad positioned within the opening, the touch pad having an arcuate contact surface curved inwardly with respect to the opening toward a central axis of the touch pad.

2. The touch pad module according to claim 1 wherein the arcuate contact surface follows an arc defined by a user's fingertip contacting the arcuate contact surface as the user's wrist rotates to move the fingertip in a transverse direction on the arcuate contact surface.

3. The touch pad module according to claim 1 wherein the central axis is positioned on a centerline of the touch pad extending at least partially between a front edge of the touch pad and an opposite rear edge of the touch pad.

4. The touch pad module according to claim 3 wherein the centerline extends from the front edge to the rear edge and each of a first lateral edge and a second lateral edge curve inwardly with respect to the opening toward the centerline.

5. The touch pad module according to claim 1 wherein the arcuate contact surface is a concave surface.

6. The touch pad module according to claim 1 wherein the arcuate contact surface has a radius of curvature of 105 millimeters (mm) to 120 mm between a first lateral edge of the touch pad and an opposite second lateral edge of the touch pad.

7. The touch pad module according to claim 1 wherein the arcuate contact surface is curved inwardly from a first lateral edge to the central point at an angle of 19.6° to 17.4°.

8. The touch pad module according to claim 1 wherein the arcuate contact surface has a negative slope along a centerline of the touch pad between a front edge of the arcuate contact surface and an opposite rear edge of the arcuate contact surface.

9. The touch pad module according to claim 1 wherein the arcuate contact surface has a positive slope along a centerline of the touch pad between a front edge of the arcuate contact surface and an opposite rear edge of the arcuate contact surface.

10. The touch pad module according to claim 1 further comprising at least one button positioned within an additional opening defined in the housing.

11. A remote input system for a vehicle, the remote input system comprising:
a touch pad module, comprising:
a housing disposed at least one of on and at least partially within a center console of the vehicle, the housing defining an opening; and
a touch pad positioned within the opening, the touch pad having an arcuate contact surface curved inwardly with respect to the opening toward a central axis of the touch pad; and
a display coupled in signal communication with the touch pad module for presenting selectable information for one or more systems of the vehicle based at least in part on one or more signals received from the touch pad module.

12. The remote input system according to claim 11, wherein the touch pad module transmits a signal to a controller including a processor in signal communication with the display when a user touches the arcuate contact surface of the touch pad.

13. The remote input system according to claim 12, wherein the signal is representative of one of a user touching the arcuate contact surface to perform a selection and sliding a finger along the arcuate contact surface to highlight one of a plurality of selectable selections.

14. The remote input system according to claim 12, wherein detection of a user touch substantially along the central axis corresponds to highlighting of a selectable selection substantially along a central axis of the display.

15. The remote input system according to claim 13, wherein performing a selection results in one of providing more selectable information for one system, activating one system, deactivating one system, and adjusting one or more parameters for one system.

16. The remote input system of claim 11, wherein the touch pad module further includes a first button and a second button.

17. The remote input system of claim 15, wherein a first signal is communicated to a controller including a processor in signal communication with the display when the first button is depressed and in response to the first signal the selectable information presented on the display is a first set of selectable information.

18. The remote input system of claim 16, wherein a second signal is communicated to the processor when the second button is depressed and in response to the second signal the selectable information presented on the display is changed to one of a previous set of selectable information and the first set of selectable information.

19. The remote input system of claim 12, wherein the signal relates a first location of the touch by the user on the arcuate contact surface to a second location on the display and the selectable information corresponding to the second location is highlighted.

20. The remote input system of claim 11, wherein each of one or more selectable selections presented on the display corresponds to a region on the arcuate contact surface and a signal is communicated to a controller including a processor in signal communication with the display from the touch pad module to one of perform a selection and highlight a selection corresponding to a region of the arcuate contact surface touched by a user.

21. The remote input system of claim 11, wherein a signal is communicated to a controller including a processor in signal communication with the display from the touch pad module to select a selection presented on the display when a user presses on the arcuate contact surface actuating a switch in communication with the arcuate contact surface.

22. The remote input system according to claim 12, wherein the touch pad is configured to detect a user tapping the arcuate contact surface with at least one fingertip to select selectable information presented on the display.

23. The remote input system according to claim 12, wherein the touch pad is configured to detect a user sliding two fingertips in contact with the arcuate contact surface transversely to the central axis to transition the information presented on a display between one of systems of the vehicle and pages of selectable information.

24. The remote input system according to claim 12, wherein the touch pad is configured to detect a user sliding two fingertips in contact with the arcuate contact surface parallel to the central axis to scroll the selectable information presented on a display vertically.

25. The remote input system according to claim 12, wherein the touch pad is configured to detect a user sliding two fingertips in contact with the arcuate contact surface in one of a circular pattern or rotational pattern to rotate an image presented on the display.

26. The remote input system according to claim 12, wherein the display is configured to present a menu of selectable information when the touch pad detects a user touching the arcuate contact surface with at least one fingertip.

27. A method of controlling a remote input system for a vehicle, the remote input system including a touch pad module including a touch pad having an arcuate contact surface, the touch pad module disposed on a center console of a vehicle, wherein the arcuate contact surface follows an arc defined by a user's fingertip contacting the arcuate contact surface as the user's wrist rotates to move the fingertip in a transverse direction on the arcuate contact surface, and a display coupled in signal communication with the touch pad module, the method comprising:
communicating a signal from the touch pad to a processor in signal communication with the display when a user moves a finger along the arcuate contact surface of the touch pad to a region of the arcuate contact surface;
highlighting indicia presented on the display representative of information of a system of the vehicle in response to the signal from the touch pad; and
selecting, via the arcuate contact surface, the highlighted indicia.

28. The method of claim 26, wherein selecting, via the arcuate contact surface, the highlighted indicia is performed by one of touching the arcuate contact surface and pressing on the arcuate contact surface to actuate a switch.

29. The method of claim 27, wherein selecting, via the arcuate contact surface, the highlighted indicia results in one of providing new indicia presented on the display representative of information of a system of the vehicle, activating the system, deactivating the system, and adjusting one or more parameters for the system.

30. The method of claim 28, further comprising:
communicating a first signal to the processor in signal communication with the display in response to the user depressing a first button of the touch pad module; and
changing the indicia presented on the display representative of information of the system of the vehicle to a first set of indicia in response to the first signal.

31. The method of claim 29, wherein the remote input system further includes a second button, the method further comprising:
communicating a second signal to the processor in response to the user depressing a second button of the touch pad module; and
changing the indicia to a previous set of indicia in response to the second signal.
